(19) United States
(12) Patent Application Publication
(10) Pub. No.: US 2021/0271856 A1
(43) Pub. Date: Sep. 2, 2021

(54) CAMERA SHUTTERS WITH LIGHT FILTERS

(71) Applicant: Hewlett-Packard Development Company, L.P., Spring, TX (US)

(72) Inventors: Derek Kyle Kanas, Spring, TX (US); Travis Lee Humphries, Spring, TX (US); Alan Manpan Tam, Spring, TX (US); Kent Edward Biggs, Spring, TX (US)

(73) Assignee: Hewlett-Packard Development Company, L.P., Spring, TX (US)

(21) Appl. No.: 17/261,587

(22) PCT Filed: Nov. 12, 2018
(86) PCT No.: PCT/US2018/060572

§ 371 Date: Jan. 20, 2021

(51) Int. Cl. G06K 9/00; H04N 5/225; G03B 11/04; G02B 5/20; G06F 21/32; G06F 1/16

(52) U.S. Cl. CPC G06K 9/00268; H04N 5/2252; H04N 5/2254; G06F 1/1686; G02B 5/208; G06F 21/32; G03B 11/043

(57) ABSTRACT

An example computer device includes a housing, a camera disposed in the housing, a processor disposed in the housing, and a shutter coupled to the housing. The camera receives visible light and infrared light. The processor carries out facial recognition authentication using the infrared light received by the camera. The shutter includes a filter to block visible light and allow passage of infrared light. The shutter is selectively movable to a filtered position, wherein the filter is superimposed over the camera to block visible light and allow infrared light to reach the camera for the facial recognition authentication.

### BACKGROUND

Computer devices may include cameras to capture images and video. A person may use such a camera to capture still images of the person or the person's surroundings or to communicate with others via a computer network. A computer-based camera may also be used to grant access to the computer device using facial recognition.

### BRIEF DESCRIPTION OF THE DRAWINGS

FIG. 1 is a perspective view of an example computer device with a selectively movable shutter to allow passage of infrared light.

FIG. 2 is a perspective view of another example computer device with a manually selectively movable shutter to allow passage of infrared light.

FIG. 3 is a close-up view of a camera and the selectively movable shutter of the computer device of FIG. 2 in an open position.

FIG. 4 is a close-up view of a camera and the selectively movable shutter of the computer device of FIG. 2 in a filtered position.

FIG. 5 is a perspective view of another example computer device with a manually selectively movable shutter to allow passage of infrared light.

FIG. 6 is a close-up view of a camera and the selectively movable shutter of the computer device of FIG. 5 in an open position.

FIG. 7 is a close-up view of a camera and the selectively movable shutter of the computer device of FIG. 5 in a filtered position.

FIG. 8 is a close-up view of a camera and the selectively movable shutter of the computer device of FIG. 5 in a closed position.

FIG. 9 is a perspective view of an example computer device with an electrically selectively movable shutter to allow passage of infrared light.

### DETAILED DESCRIPTION

Users of computer devices may use shutters which block cameras in order to obtain privacy when the camera is not in use. When a camera includes the capability to capture infrared images, a user may still wish to utilize this feature for facial recognition applications, such as authentication, for example to log in to the computer. When a visible light camera is integrated with an infrared camera, a user may open a shutter to allow access to the infrared camera for facial recognition applications. The user may then close the shutter after the facial recognition is complete. This process leaves the vulnerable to exposure to the visible light camera during the facial recognition process and creates an additional step for the user to undertake.

A computer device may include an integrated visible light and infrared (IR) light camera. The computer device may include a privacy shutter having a filter to block visible light and allow IR light to reach the camera to allow a user to use the IR sensor while the camera is covered to provide privacy. The filter may include a thin visible light filter film attached to a privacy shutter. The privacy shutter may then be assembled with a bezel of the computer device. The shutter may be moved mechanically or electrically. In addition, the shutter may include a closed portion to block both IR and visible light. The closed portion can be made of any opaque material such as mylar.

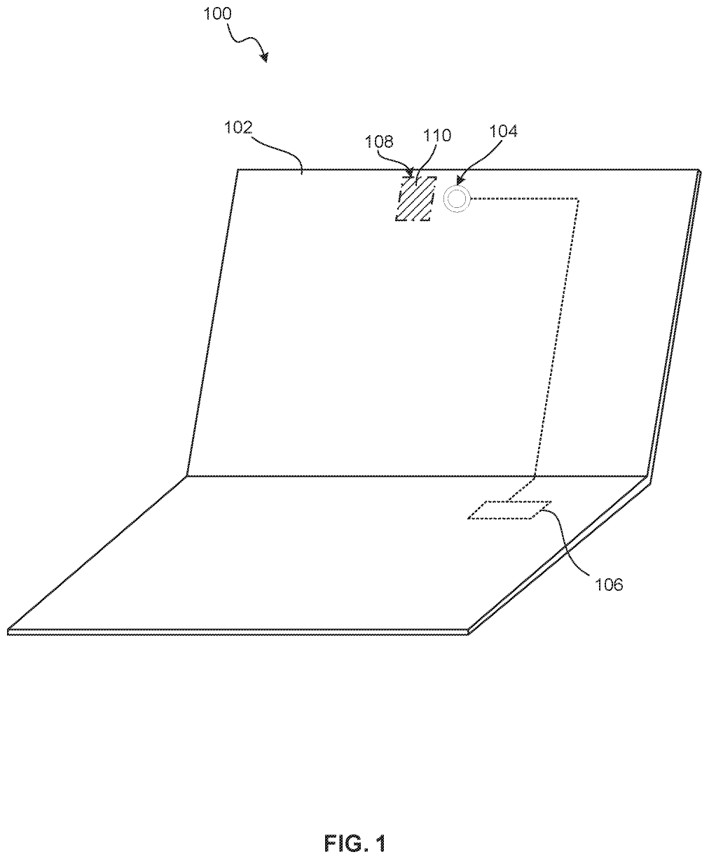

FIG. 1 shows an example computer device 100, such as a laptop or notebook computer. The computer device 100 includes a housing 102, a camera 104, a processor 106, and a shutter 108. The camera 104 is disposed in the housing 102 and may be physically connected to the housing 102. The processor 106 may be contained in the housing 102. The housing 102 may include several portions and the camera 104 and the processor 106 may be located in different portions.

The camera 104 receives visible light and infrared light. The camera 104 may include a visible light image sensor to capture visible light image data for regular camera use (i.e., to capture images and video), an infrared light image sensor to capture infrared light for use in facial recognition, or an integrated visible light and infrared image sensor. In particular, the camera 104 integrates both visible light and infrared light image data capture capabilities.

The shutter 108 is coupled to the housing 102. The shutter 108 includes a filter 110 to block visible light and allow passage of infrared light. The shutter 108 is selectively movable to a filtered position, wherein the filter 110 is superimposed over the camera to block visible light and allow infrared light to reach the camera.

The processor 106 is coupled to the camera 104. The processor 106 may include a central processing unit (CPU), a microcontroller; a microprocessor; a processing core, a field-programmable gate array (FPGA), or similar device capable of executing instructions. The processor 106 may cooperate with memory to execute instructions. Memory may include a non-transitory machine-readable storage medium that may be ay electronic, magnetic, optical, or other physical storage device that stores executable instructions. The machine-readable storage medium may include, for example; random access memory (RAM); read-only memory (ROM); electrically-erasable programmable read-only memory (EEPROM), flash memory, a storage drive, an optical disc, and the like. The machine-readable storage medium may be encoded with executable instructions.

The processor 106 is to use the infrared light image data captured by the camera 104 for facial recognition authentication. When the camera 104 captures infrared light image data representing a user's face, the processor 106 may identify facial features and patterns for verification against stored facial features and patterns of an authorized user.

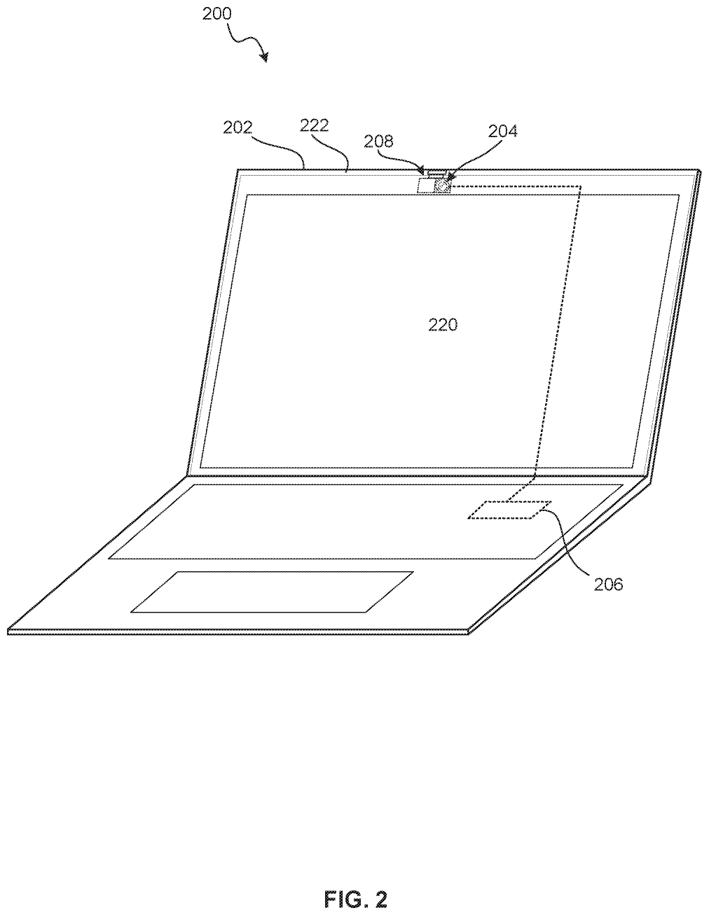

FIG. 2 shows an example computer device 200. The computer device 200 includes a housing 202, a camera 204, a processor 206, and a shutter 208. The housing 202 contains a display device 220, the camera 104, the shutter 208, and the processor 206. The housing 202 can also include a bezel 222 surrounding the display device 220. The housing 202 may also include a user input device, such as a keyboard, touchpad, and similar.

The camera 204 is similar to the camera 104 and receives visible light and infrared light for regular camera use and for facial recognition applications respectively. In particular, the camera 204 integrates both visible light and infrared light image data capture capabilities. The processor 206 is similar to the processor 106 and is coupled to the camera 204 to use the infrared light image data captured by the camera 204 for facial recognition applications, such as authentication.

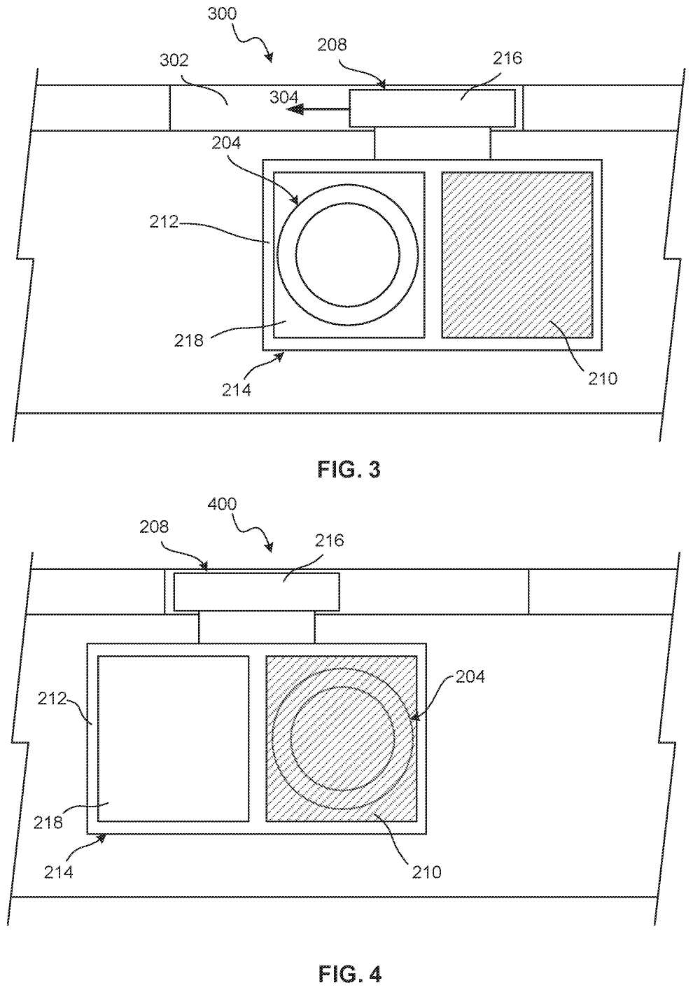

With reference to FIGS. 3 and 4, the shutter 208 includes a filter 210, a frame 212, an open portion 214, and a slider 216 that may be shaped to be manually slid by a user's fingertip. The frame 212 may include plastics or other suitable material to support the filter 210 and the open portion 214, and to couple the filter 210 and the open portion 214 to the slider 216. In some examples, the shutter 208 omits the open portion 214.

The open portion 214 allows passage of both visible light and infrared light to be received by the camera 104. The open portion 214 may include an aperture 218 in the frame 212 to allow both visible light and infrared light to be received by the camera 104. In some examples, the open portion 214 may include a film transparent to both visible light and infrared light. The film may include glass, plastics, or other suitable materials supported on the frame 212. The shutter 208 is selectively movable to an open position 300, as shown in FIG. 3, wherein the open portion 214 is superimposed over the camera 104. When the shutter 208 is in the open position 300, the camera 104 operates in an open mode, wherein the camera 104 captures both visible light image data and infrared light image data. That is, in the open mode, the open portion 214 allows visible light to be received by the camera 104, and hence the camera 104 captures visible light image data for regular camera use. Similarly, the open portion 214 allows infrared light to be received by the camera 104, and hence the camera 104 captures infrared light image data for facial recognition applications.

In some examples, the shutter 208 may not include an open portion 214. In such examples, the shutter 208 is selectively movable to an open position wherein the filter 210 is not superimposed over the camera 104. The camera 104 is therefore operable in the open mode to capture both visible light image data and infrared light image data. That is, the filter 210 is not in a position to block visible light or infrared light from being received by the camera 104, and hence the camera 104 captures both visible light image data and infrared light image data.

The filter 210 blocks visible light and allows passage of infrared light. The filter 210 may include a thin infrared pass film supported on the frame 212. The infrared pass film blocks most wavelengths within the visible light spectrum, and passes higher wavelength light, including infrared light. The shutter 208 is selectively movable to a filtered position 400, as shown in FIG. 4, wherein the filter 210 is superimposed over the camera 104. When the shutter 208 is in the filtered position 400, the camera 104 operates in a filtered mode, wherein the camera 104 captures only infrared light image data. In particular, the filter 210 prevents visible light from being received by the camera 104, and hence no visible light image data is captured by the camera 104 in the filtered mode. In contrast, the filter 210 allows infrared light to reach the camera, and hence, in the filtered mode, the camera 104 captures infrared light image data. That is, in the filtered mode, the camera 104 may be used for facial recognition applications and cannot capture visible light image data for regular camera use.

For example, when the shutter 208 is in the open position 300, an imaging application on the computer device 200 may display the image data captured by the camera 204. When the shutter 208 is in the filtered position 400, the imaging application may display a black screen, indicating to a user that visible light is not received by the camera 204.

As seen in FIGS. 3 and 4, the shutter 208 includes a slider 216 for a user to manually selectively move the shutter 208 to the filtered position 400 or to the open position 300. In the present example, the slider 216 forms a portion of the bezel 222 of the housing 202. In particular, the bezel 222 includes a slot 302 in which the slider 216 is contained. The slider 216 is slidable along the slot 302 of the bezel 222 in a direction 304 to move from the open position 300 to the filtered position 400, wherein the filter 210 is superimposed over the camera 104.

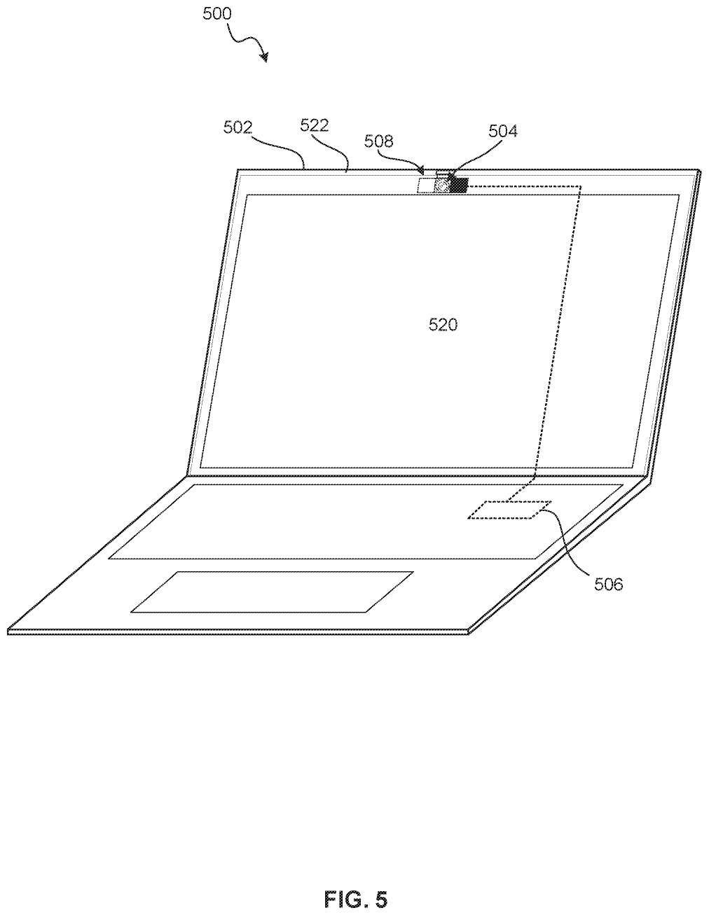

FIG. 5 shows an example computer device 500. The computer device 500 includes a housing 502, a camera 504, a processor 506, and a shutter 508. The housing 502 contains a display device 520, the camera 504, the shutter 508, and the processor 506. The housing 502 may also include a bezel 522 surrounding the display device 520. The housing 502 may also include a user input device, such as a keyboard, touchpad, and similar.

The camera 504 is similar to the cameras 104 and 204 and receives visible light and infrared light for regular camera use and for facial recognition applications respectively. In particular, the camera 504 integrates both visible light and infrared light image data capture capabilities. The processor 506 is similar to the processor 106 and is coupled to the camera 504 to use the infrared light image data captured by the camera 504 for facial recognition applications, such as authentication.

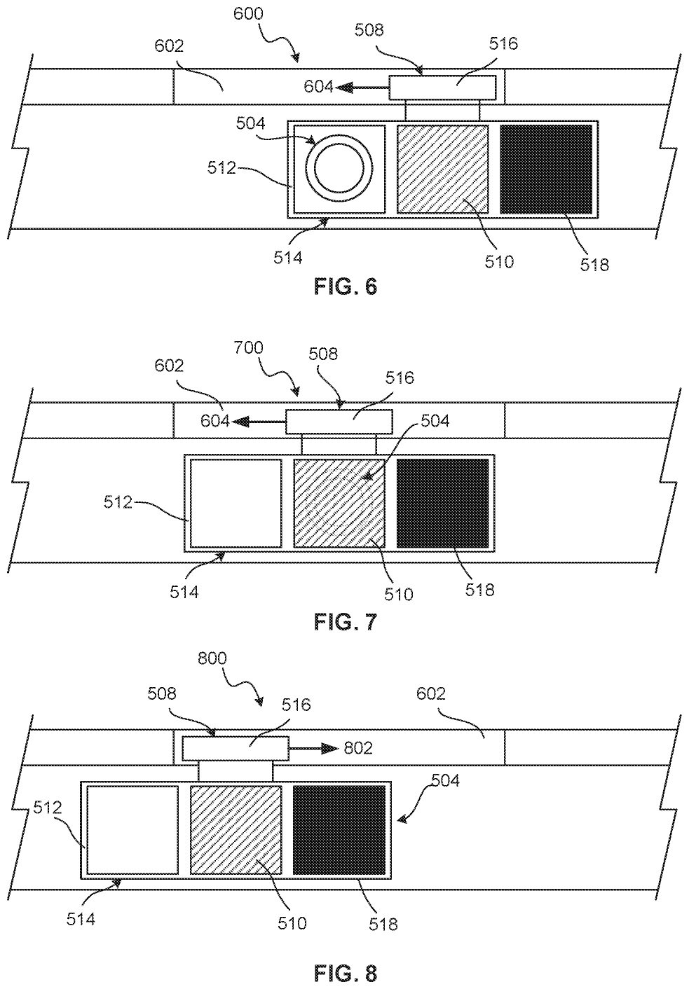

With reference to FIGS. 6 to 8, the shutter 508 includes a filter 510, a frame 512, an open portion 514, a slider 516, and a closed portion 518. The frame 512 is similar to the frame 212 and may include plastics or other suitable material to support the filter 510, the open portion 514, and the closed portion 518, and to couple the filter 510, the open portion 514, and the closed portion 518 to the slider 516.

The open portion 514 is similar to the open portion 214, and may include an aperture, a transparent film, or other suitable structure to allow both visible light and infrared light to be received by the camera 104. The shutter 508 is selectively movable to the open position 600, shown in FIG. 6, wherein the open portion 514 is superimposed over the camera 104. When the shutter 508 is in the open position 600, the camera 104 operates in the open mode to capture both visible light image data and infrared light image data.

The filter 510 is similar to the filter 210 and may include an infrared pass film or other suitable structure to allow passage of infrared light, while blocking visible light. The shutter 508 is selectively movable to the filtered position, wherein the filter 510 is superimposed over the camera 104. In the filtered position, shown in FIG. 7, the camera 104 operates in the filtered mode, wherein the camera 104 captures only infrared light image data. In particular, the filter 510 prevents visible light from being received by the camera 104, and hence no visible light image data is captured by the camera in the filtered mode.

The closed portion 518 blocks both visible light and infrared light. The closed portion 518 may include a film, for example, formed of mylar, or other suitable structure opaque to both visible light and infrared light. The shutter 508 is selectively movable to a closed position 800, shown in FIG. 8, wherein the closed portion 518 is superimposed over the camera 104. When the shutter 508 the closed position 800, the camera 104 operates in a closed mode, wherein the camera 104 is prevented from capturing visible light image data and infrared light image data. In particular, the closed portion 518 prevents visible light from being received by the camera 104, and hence no visible light image data is captured by the camera 104 in the closed mode. Similarly, the closed portion 518 prevents infrared light from being received by the camera 104, and hence no infrared light image data is captured by the camera 104 in the closed mode.

The shutter 508 further includes the slider 516 for a user to manually selectively move the shutter 208 to open position 600, to the filtered position 700 and to the closed position 800. In particular, the slider 516 is slidable along a slot 602 of the bezel 522 in a direction 604 to move from the open position 600 to the filtered position 700 and to the closed position 800, and in a direction 802 to move from the closed position 800 to the filtered position 700 and to the open position 600.

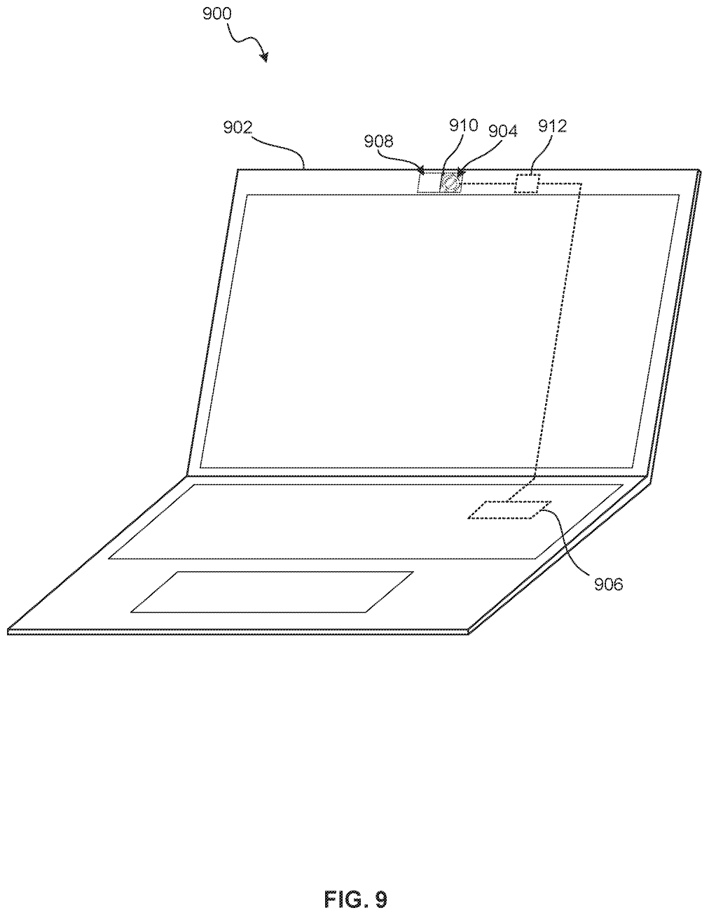

FIG. 9 shows an example computer device 900. The computer device 900 includes a housing 902, a camera 904, a processor 906, a shutter 908, and a solenoid 912. The housing 902 contains the camera 904, the processor 906, and the shutter 908. The housing 902 may further include a display device and user input devices, such as a keyboard, touchpad, and similar.

The camera 904 receives visible light and infrared light for regular camera use and for facial recognition applications respectively. In particular, the camera 904 integrates both visible light and infrared light image data capture capabilities. The processor 906 is coupled to the camera 904 to use the infrared light image data captured by the camera 904 for facial recognition applications, such as authentication.

The shutter 908 includes a filter 910 to block visible light and allow passage of infrared light. The shutter 908 is selectively movable to a filtered position, wherein the filter 910 is superimposed over the camera to block visible light and allow infrared light to reach the camera 904.

The solenoid 912 is coupled to the shutter 908 and the processor 906 to electrically selectively move the shutter 908 to the filtered position. For example, a user may enter a command to move the shutter 908 to the filtered position by selecting an option, or a keyboard shortcut, or similar. The processor 906 may relay the command to the solenoid 912, which converts the instruction to a mechanical movement of the shutter 908 from an open position to the filtered position.

It should be apparent from the above that a computer device having an integrated visible light and infrared light camera may include a selectively movable shutter having a visible light filter. The shutter blocks visible light, thereby providing privacy to a user, and allows passage of infrared light to allow the user to use facial recognition applications. The user may selectively move the shutter to an appropriate position, such as an open position, or a filtered position, according to a desired mode of operation of the camera. The filter may give the user a visual confirmation that images or video cannot be captured, while still allowing facial recognition or similar process using infrared light to occur.

The scope of the claims should not be limited by the above examples, but should be given the broadest interpretation consistent with the description as a whole.

1. A computer device comprising
a housing;
a camera disposed in the housing, the camera to receive visible light and infrared light;
a processor disposed in the housing, the processor to carry out facial recognition authentication using the infrared light received by the camera; and
a shutter coupled to the housing, the shutter having a filter to block visible light and allow passage of infrared light, the shutter selectively movable to a filtered position wherein the filter is superimposed over the camera to block visible light and allow infrared light to reach the camera for the facial recognition authentication.

2. The computer device of claim 1, wherein the shutter further includes an open portion to allow passage of both visible light and infrared light, the shutter selectively movable to an open position, wherein the open portion is superimposed over the camera to both visible light and infrared light to be received by the camera.

3. The computer device of claim 1, wherein the shutter further includes a closed portion to block both visible light and infrared light, the shutter selectively movable to a closed position, wherein the closed portion is superimposed over the camera to block both visible light and infrared light from being received by the camera.

4. The computer device of claim 1, wherein the shutter includes a slider to manually selectively move the shutter to the filtered position.

5. The computer device of claim 4, wherein the slider forms a portion of a bezel of the housing.

6. The computer device of claim 1, further comprising a solenoid coupled to the shutter; the solenoid to electrically selectively move the shutter to the filtered position.

7. A computer device comprising:
a housing;
a camera disposed in the housing;
a processor disposed in the housing, the processor to carry out facial recognition authentication; and
a shutter coupled to the housing, the shutter movable to allow the camera to operate in:
an open mode, wherein the camera is to capture both visible light image data and infrared light image data, the infrared light image data for the facial recognition authentication; and
a filtered mode; wherein the camera is to capture only infrared light image data, the infrared light image data for the facial recognition authentication, and wherein the shutter is to prevent the camera from capturing visible light image data.

8. The computer device of claim 7, wherein the shutter is further selectively movable to allow the camera to operate in a closed mode; wherein the shutter is to prevent the camera from capturing visible light image data and infrared light image data.

9. The computer device of claim 7, wherein the shutter includes a slider to manually selectively move the shutter.

10. The computer device of claim 9, wherein the slider forms a portion of a bezel of the housing.

11. The computer device of claim 7, further comprising a solenoid coupled to the shutter, the solenoid to electrically selectively move the shutter.

12. A computing device comprising:
a housing;
a camera disposed in the housing;
a shutter including a frame, wherein the shutter is coupled to the housing via the frame;
an open portion supported on the frame; the open portion to allow passage of both visible light and infrared light to the camera when the open portion is superimposed over the camera;
a filter supported on the frame, the filter to block visible light and allow passage of infrared light to the camera when the filter is superimposed over the camera; and
wherein the shutter is selectively movable to an open position, wherein the open portion is superimposed over the camera, and to a filtered position, wherein the filter is superimposed over the camera.

13. The computing device of claim 12, wherein the filter comprises an infrared pass film.

14. The computing device of claim 12, wherein the open portion comprises an aperture in the frame.

15. The computing device of claim 12, further comprising a closed portion supported on the frame, the closed portion to block both visible light and infrared light from reaching the camera when the closed portion is superimposed over the camera; and wherein the shutter is further selectively movable to a closed position, wherein the closed portion is superimposed over the camera.
